(19) United States
(12) Patent Application Publication
(10) Pub. No.: US 2021/0144611 A1
(43) Pub. Date: May 13, 2021

(54) ALTITUDE POSITION STATE BASED MOBILE COMMUNICATIONS

(71) Applicant: Nokia Technologies Oy, Espoo (FI)

(72) Inventors: Jeroen Wigard, Klarup (DK); Istvan Zsolt Kovacs, Aalborg (DK); Frank Frederiksen, Klarup (DK); Rafhael Amorim, Aalborg (DK); Huan Cong Nguyen, Aalborg (DK)

(21) Appl. No.: 16/492,180

(22) PCT Filed: Mar. 14, 2017
(86) PCT No.: PCT/FI2017/050164

§ 371 Date: Sep. 9, 2019

(51) Int. Cl. H04W 36/32; H04W 36/00

(52) U.S. Cl. CPC H04W 36/32; H04W 36/00837; H04W 36/0058

(57) ABSTRACT

A serving network node may be configured to determine an altitude position state of a terminal device. The altitude position state may be determined using information in a plurality of reports received from the terminal device, the reports comprising at least one indication of signal reception quality (201). For example, the altitude position state may be determined by comparing the at least one indication of the signal reception quality of the plurality of reports to a comparison model, or by comparing cells in the plurality of reports to information of cells in a certain area (202). Further, more reports may be requested from the terminal device for improved certainty of the determining, if needed. The determined altitude position state of the terminal device may further be transmitted, as a part of a handover process, to a handover target network node (203).

### TECHNICAL FIELD

The invention relates to communications.

### BACKGROUND

In recent years the versatility of different terminal devices wireless networks are serving has increased. Unmanned aerial vehicles or remote-controlled pilotless aircrafts, also called drones, are becoming increasingly popular in both of several kind of professional usage as well as in consumer usage. It is anticipated that drones themselves may comprise, in addition to a wireless control interface, a further wireless interface providing connectivity to cellular networks, for one or more applications, like uplink video streaming from a camera, in a drone. It is also possible that such a device is on board of a drone.

### BRIEF DESCRIPTION

As to an aspect, there is provided a method comprising receiving, by a serving network node, from a terminal device, a plurality of reports comprising at least one indication of signal reception quality; determining, by the serving network node, an altitude position state of the terminal device based on comparing the at least one indication of the signal reception quality of the plurality of reports to a comparison model or based on comparing cells in the plurality of reports to information of cells in a certain area, and requesting more reports from the terminal device for improved certainty of the determining, if needed, and; transmitting, as a part of a handover process, the determined altitude position state of the terminal device to a handover target network node.

In a further aspect, the altitude position state comprises terrestrial or airborne.

In a still further aspect the at least one indication of the signal reception quality of the plurality of the reports comprises at least one of the following: at least one parameter representing received signal level in a cell provided by the serving network node and at least one parameter representing received signal level in at least one neighbor cell.

In a still further aspect the comparison model comprises a decision equation using the at least one parameter representing wideband interference, a configuration parameter, an environment parameter and a decision line, and one of the following: the at least one parameter representing received signal level in the cell provided by the serving network node, the at least one parameter representing received signal level in the at least one neighbor cell and at least one parameter indicating wideband interference level.

In a still further aspect the determining based on the comparing the cells in the plurality of the reports comprises: in the case the information on the cells in the certain area comprises cells measurable by a terminal device having a terrestrial altitude position state and the cells in the plurality of the reports match to the information, the altitude position state of the terminal device is determined as terrestrial and in the case the information on the cells in the certain area comprises cells measurable by a terminal device having an airborne altitude position state and the cells in the plurality of the reports match to the information, the altitude position state of the terminal device is determined as airborne.

In a still further aspect, the method comprises detecting that the terminal device altitude position state has changed, and transmitting information on the altitude position state to the terminal device.

In a still further aspect, the method comprises transmitting, to the handover target node, mobility state information comprising at least one of the following: a type of the at least one indication of the signal reception quality of the plurality of the reports, the number of the plurality of the reports, time period during which the receiving and determining were carried out and a level of the certainty of the determining.

In a still further aspect, the method comprises the mobility state information further comprises at least one of the following: a movement vector and at least one last received indication of the signal reception quality.

In a still further aspect, the method comprises requesting more reports from the terminal device, by updating, by the serving network node, measurements triggers of the terminal device to more frequent reporting; and updating, in response to detecting that there is not any more need for the improved certainty, by the serving network node, measurements triggers of the terminal device to less frequent reporting.

In a still further aspect, the method comprises causing sending from the serving network node to the terminal de-vice a value for a configuration parameter and a value for an environment parameter for measurements report event triggers to trigger sending of measurements reports.

In a still further aspect, the method comprises detecting, by the terminal device, a measurement report event in response to an equation using the configuration parameter, the environment parameter, a hysteresis and at least two different measured indications of the signal reception quality is fulfilled; and causing, in response to detecting a measurements report event, sending a measurement report from the terminal device to the serving network node.

As to another aspect there is provide a network node comprising at least one processor, and at least one memory comprising a computer program code, wherein the processor, the memory, and the computer program code are configured to cause the network node to: determine an altitude position state of a terminal device, on which a plurality of reports comprising at least one indication of signal reception quality of the terminal device, or corresponding information, have been received, based on comparing the at least one indication of the signal reception quality of the plurality of reports to a comparison model or based on comparing cells in the plurality of reports to information of cells in a certain area, and requesting more reports from the terminal device for improved certainty of the determining, if needed, and transmit, as a part of a handover process, the determined altitude position state of the terminal device to a handover target network node.

In a still further aspect, the processor, the memory, and the computer program code are further configured to cause the network node to determine the altitude position state of the terminal device based on a decision equation in the comparison model, the decision equation using a configuration parameter, an environment parameter and a decision line, and one of the following: the at least one parameter representing received signal level in the cell provided by the serving network node, the at least one parameter representing received signal level in the at least one neighbor cell and at least one parameter indicating wideband interference level.

In a still further aspect, the processor, the memory, and the computer program code are further configured to cause the network node to determine the altitude position state of the terminal device, based on the comparing the cells in the plurality of the reports, to be as terrestrial in the case the information on the cells in the certain area comprises cells measurable by a terminal device having a terrestrial altitude position state and the cells in the plurality of the reports match to the information, and to be as airborne in the case the information on the cells in the certain area comprises cells measurable by a terminal device having an airborne altitude position state and the cells in the plurality of the reports match to the information.

In a still further aspect, the processor, the memory, and the computer program code are further configured to cause the network node to transmit to the handover target node, mobility state information comprising at least one of the following: a type of the at least one indication of the signal reception quality of the plurality of the reports, the number of the plurality of the reports, time period during which the receiving and determining were carried out and a level of the certainty of the deter-mining.

In a still further aspect, the processor, the memory, and the computer program code are further configured to cause the network node to use in determining the altitude position state of the terminal device mobility state information received as a handover target node of the terminal device, the mobility state information comprising at least one of the following: a type of the at least one indication of the signal reception quality of the plurality of the reports, the number of the plurality of the reports, time period during which the receiving and determining were carried out and a level of the certainty of the determining.

As to another aspect, there is provided a network node comprising at least one processor, and at least one memory comprising a computer program code, wherein the processor, the memory, and the computer program code are configured to cause the network node to determine an altitude position state of a terminal device, and transmit, as a part of a handover process, the determined altitude position state of the terminal device to a handover target network node.

In a still further aspect, the processor, the memory, and the computer program code are further configured to cause the network node to detect that the terminal device altitude position state has changed; and transmit information on the altitude position state to the terminal device.

As to another aspect, there is provided a terminal device comprising at least one processor, and at least one memory comprising a computer program code, wherein the processor, the memory, and the computer program code are configured to cause the terminal device to configure measurement report event triggers to be in accordance with a value for a configuration parameter and a value for an environment parameter in response to receiving the values from a serving network node; detect a measurement report event in response to an equation, which uses the configuration parameter, the environment parameter, a hysteresis and at least two different measured indications of the signal reception quality of the terminal device, being fulfilled; and cause, in response to detecting a measurements report event, sending a measurements report from the terminal device to the serving network node.

In a still further aspect, the processor, the memory, and the computer program code are further configured to cause the terminal device to update its altitude position state in response to receiving information on the altitude position state of the terminal device from the serving network node.

In a still further aspect, the value for the configuration parameter and the value for the environment parameter are received by the terminal device as a broadcast or in dedicated signaling.

As to another aspect, there is provided a non-transitory computer readable media having stored thereon instructions that, when executed by a computing device, cause the computing device to determine an altitude position state of a terminal device, on which a plurality of reports comprising at least one indication of signal reception quality of the terminal device, or corresponding information, have been received, based on comparing the at least one indication of the signal reception quality of the plurality of reports to a comparison model or based on comparing cells in the plurality of reports to information of cells in a certain area, and requesting more reports from the terminal device for improved certainty of the determining, if needed, and transmit, as a part of a handover process, the determined altitude position state of the terminal device to a handover target network node.

As to another aspect, there is provided a distributed computing system, comprising a server and a radio node, the server configured to receive from the radio node a plurality of reports comprising at least one indication of signal reception quality at a terminal device the radio node provides a serving radio cell, determine an altitude position state of the radio node based on com-paring the at least one indication of the signal reception quality of the plurality of the reports to a comparison model or based on comparing cells in the plurality of the reports to information of cells in a certain area, request more reports from the radio node for improved certainty of the determining, if needed, and transmit the determined altitude position state to the radio node; and the radio node configured to transmit the plurality of reports to the server and, in response to being requested, transmit the more reports after requested and received from the terminal device to the server, receive the altitude position state of the terminal device, and transmit, as a part of a handover process, the altitude position state of the terminal device to a handover target network node.

In a still further aspect, the radio node is further configured to transmit to the terminal device at least a configuration parameter value and an environment parameter value; and the terminal device configured to detect a measurement report event in response to an equation, which uses the configuration parameter, the environment parameter, a hysteresis and at least two different measured indications of the signal reception quality of the terminal device, being fulfilled, and send, in response to detecting the measurements report event, a measurements report from the terminal device to the radio node.

One or more examples of implementations are set forth in more detail in the accompanying drawings and the description below. Other features will be apparent from the description and drawings, and from the claims.

### BRIEF DESCRIPTION OF DRAWINGS

In the following embodiments will be described in greater detail with reference to the attached drawings, in which

FIGS. 1A and 1B illustrate examples of wireless communication systems with schematic block diagrams of some nodes;

FIG. 2 shows an example of a method;

FIG. 3 illustrates an example how parameters may be defined;

FIGS. 4 to 12 illustrate examples of processes; and

FIGS. 13 and 14 are schematic block diagrams.

### DETAILED DESCRIPTION OF SOME EMBODIMENTS

The following embodiments are only presented as examples. Although the specification may refer to “an”, “one”, or “some” embodiment(s) and/or example(s) in several locations of the text, this does not necessarily mean that each reference is made to the same embodiment(s) or example(s), or that a particular feature only applies to a single embodiment and/or example. Single features of different embodiments and/or examples may also be combined to provide other embodiments and/or examples.

Embodiments and examples described herein may be implemented in any communications system, wired or wireless, that are configured to support mobility of user devices by handovers, such as in at least one of the following: Universal Mobile Telecommunication System (UMTS, 3G) based on basic wideband-code division multiple access (W-CDMA), high-speed packet access (HSPS), Long Term Evolution (LTE), LTE-Advanced, LTE-Advanced Pro, fifth generation (5G) system, beyond 5G, and/or wireless local area networks (WLAN) based on IEEE 802.11 specifications on IEEE 802.15 specifications. The embodiments are not, however, restricted to the systems given as an example but a person skilled in the art may apply the solution to other communication systems provided with necessary properties. One example of a suitable communications system is the 5G system, as listed above. 5G has been envisaged to use multiple-input-multiple-output (MIMO) multi-antenna transmission techniques, more base stations or access nodes than the current network deployments of LTE, by using a so-called small cell concept including macro sites operating in co-operation with smaller local area access nodes, such as local ultra-dense deployment of small cells, and perhaps also employing a variety of radio technologies for better coverage and enhanced data rates. 5G will likely be comprised of more than one radio access technology (RAT), each optimized for certain use cases and/or spectrum. 5G system may also incorporate both cellular (3GPP) and non-cellular (e.g. IEEE) technologies. 5G mobile communications will have a wider range of use cases and related applications including video streaming, augmented reality, different ways of data sharing and various forms of machine type applications, including vehicular safety, different sensors and real-time control. 5G is expected to have multiple radio interfaces, including apart from earlier deployed frequencies below 6 GHz, also higher, that is cmWave and mmWave frequencies, and also being capable of integrating with existing legacy radio access technologies, such as the LTE. 5G can be deployed as a standalone system but more typically 5G will be deployed together with the LTE. The 5G device can have simultaneous connection to 5G and LTE. The multi-connectivity and aggregation can increase the user data rate and improve the connection reliability. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as inter-RI operability between cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware.

The current architecture in LTE networks is fully distributed in the radio and fully centralized in the core network. The low latency requires to bring the content close to the radio which leads to local break out and Multi-Access Edge Computing (MEC). 5G may use edge cloud and local cloud architecture. Edge Computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services and augmented reality. In radio communications, using edge cloud may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent. Some other technology advancements probably to be used are Software-Defined Networking (SDN), Big Data, and all-IP, which may change the way networks are being constructed and managed. For example, one or more of the below described network node functionalities may be migrated to any corresponding abstraction or apparatus or device. Therefore, all words and expressions should be interpreted broadly and they are intended to illustrate, not to restrict, the embodiment.

An extremely general architecture of exemplifying systems 100, 100′ to which embodiments of the invention may be applied are illustrated in FIGS. 1A and 1B. FIGS. 1A and 1B are simplified system architectures only showing some elements and functional entities, all being logical units whose implementation may differ from what is shown. It is apparent to a person skilled in the art that the system may comprise any number of the illustrated elements and functional entities.

Referring to FIG. 1A, a cellular communication system 100, formed by one or more cellular radio communication networks, such as the Long Term Evolution (LTE), the LTE-Advanced (LTE-A) of the 3rd Generation Partnership Project (3GPP), or the predicted future 5G solutions, are typically composed of one or more network nodes that may be of different type. An example of such network nodes is a base station 110, such as a next generation NodeB (NGNB), providing a wide area, medium range or local area coverage 101 for terminal devices 120, for example for the terminal devices to obtain wireless access to other networks 130 such as the Internet, either directly or via a core network. The base stations 110 are configured to determine an altitude position state of a terminal device, the altitude position state telling whether the terminal device is airborne or terrestrial. For that purpose the base station 110 comprises a state determination unit (s-d-u) 111, an enhanced handover unit (e-h-o-u) 112, as separate units or integrated together, and in a memory 113 there are values for parameters alpha and beta and #. The alpha and beta are configurable parameters, the alpha being an example of a configuration parameter and the beta an example of an environment parameter. The values for the alpha and beta may be set during network planning, delivered via an operation and maintenance subsystem, or be adjusted through self-organizing network (SON) algorithms. An example how different measurements results may be used to determine parameter values is illustrated in FIG. 3, described in more detail below. The parameter #defines the size of a decision window, i.e. how many measurement reports (samples) are needed/used to detect the altitude position state, as will be described in more detail below. Examples of different functionalities of the state determination unit 111 and the enhanced handover unit 112 will be described in more detail below.

The terminal device (TD) 120 refers to a portable computing device (equipment, apparatus), and it may also be referred to as a user device, a user terminal or a mobile terminal or a machine-type-communication (MTC) device, also called Machine-to-Machine device and peer-to-peer device, or any terminal device/wireless interface that may be integrated or detachably or fixedly mounted in an unmanned aerial device or carried by an unmanned aerial device. Such computing devices (apparatuses) include wireless mobile communication devices operating with or without a subscriber identification module (SIM) in hardware or in software, including, but not limited to, the following types of devices: mobile phone, smart-phone, personal digital assistant (PDA), handset, laptop and/or touch screen computer, e-reading device, tablet, multimedia device, sensor, actuator, video camera, telemetry appliances, and telemonitoring appliances.

The exemplified system 100′ in FIG. 1B differs from the one illustrated in FIG. 1A basically in that respect that the terminal device 120′ is configured to detect events triggering sending of measurement reports for the altitude position state detection. For that purpose the terminal device 120′ comprises an event trigger unit (e-t-u) 121 and in a memory 123 values for the parameters alpha and beta. The terminal device may receive the values through system broadcast or through dedicated signaling. Examples of different functionalities of the event trigger unit 121 will be described in more detail below. In the examples it is assumed that an existing layer 1 (L1) filtering is used, and therefore it is not described in detail herein. It should be appreciated that any L1 filtering may be used.

In the illustrated example of FIG. 1B, the base station 110′, providing coverage area 101 for terminal devices 120′, for example for the terminal devices to obtain wireless access to other networks 130, comprises the state determination unit 111, the enhanced handover unit 112, and in the memory 113, in addition to values for parameters alpha, beta and #, a value for a further parameter n. The further parameter n is to adjust when, after a handover, a state is re-detected. The value for the parameter n is smaller than or equal to the value of #.

Although not illustrated in FIGS. 1A and 1B, the terminal device may receive parameter values for #and/or for n.

An embodiment for carrying out supporting altitude position state based mobile communications is explained by the means of FIG. 2. The method may be carried out by a node, host, server or any corresponding device providing a terminal device with a serving cell. The method may also be carried out by a cloud edge computing device in cooperation of a radio node or radio front end device. It should be appreciated that the embodiment may also be useful in handover management and optimization as well as in dynamic beamforming.

Some examples of processes with regard to FIG. 2 are explained by means of FIGS. 4 to 12.

The method begins in block 200.

In block 201, a plurality of reports comprising at least one indication of signal reception quality is received from a terminal device.

The received indications may comprise: reference signal received power (RSRP) of the serving cell, reference signal received power (RSRP) of x, for example 8, strongest neighbor cells which can also be used to estimate wideband interference level (RSSI), for example, received signal quality indicator RSRQ, equal to RSRP/RSSI) and/or channel quality indicator (CQI representing the SINR of the full band or sub-bands). The indicators depend on the parameters the terminal device measures according to the applied standard.

In one embodiment, the terminal device may be configured to carry out measurements for a certain period of time and/or periodically. For saving both measuring resources and signaling resources, the terminal device may be first configured to carry out normal or basic mode measurements and, if required, trigger more frequent measurements. There may be more than two different measurement modes (normal and more than one modes with more frequent measurements).

In block 202, an altitude position state of the terminal device is determined based on comparing the at least one indication of the signal reception quality of the plurality of the reports to a comparison model or based on comparing cells in the plurality of the reports to information of cells in a certain area, and requesting more reports from the terminal device for improved certainty of the determining, if needed.

The altitude position state may be terrestrial or airborne. The altitude, or height in the air, when the terminal device is classified as airborne may differ based on regulatory requirements, geographical characters (mountain area, valley, lake, city etc.) and the comparison model may be adapted or selected based on the circumstances. The model may be made based on simulations or tests made for adapting the network for supporting drone traffic. Below some examples of making the comparison are explained in further detail, but as stated, they are examples and the models can differ case by case basis. In general, in an embodiment the comparison model comprises a decision equation using the at least one parameter representing wideband interference, a configuration parameter, an environment parameter and a decision line, and one of the following: the at least one parameter representing received signal level in the cell provided by the serving network node, the at least one parameter representing received signal level in the at least one neighbor cell and the at least one parameter representing received signal quality. Examples of standardized parameters suitable to be used are listed above in relation to block 201. An example of a comparison model and using it is shown in FIG. 3 which is explained in further detail below.

In another embodiment, the determining is carried out based on the comparing the cells in the plurality of the reports comprises: in the case the information on the cells in the certain area comprises cells measurable by a terminal device having a terrestrial altitude position state and the cells in the plurality of the reports match to the information, the altitude position state of the terminal device is determined as terrestrial and in the case the information on the cells in the certain area comprises cells measurable by a terminal device having an airborne altitude position state and the cells in the plurality of the reports match to the information, the altitude position state of the terminal device is determined as airborne.

More reports may be requested by reconfiguring a trigger of the measurement reporting or by asking the terminal device directly to start reporting with regular intervals. As soon as, with a good likelihood, it is detected that the terminal device is either on ground (terrestrial) or airborne, the measurement (reporting) mode may be returned to the normal mode in order to avoid overload from measurements. The more aggressive (more frequent) measurement reporting mode may be triggered as soon as one measurement indicates that there may be a change in an altitude position state. More detailed examples of measurement triggering are explained below.

It should be appreciated that as it is not desirable with regard to every handover to start the aggressive measurement reporting for all terminal devices, as it causes unnecessary measurement overload and drains the terminal device's battery, it is desirable to know the state of the terminal device when a handover is carried out. Thus, the information of the terminal device being airborne or ground based needs to be passed from a source cell to a target cell. This requires a single bit of information exchanged between a source node and a target node. In some embodiments, the information could be coupled to a softer metric, such as a probability or reliability of the detected mode of operation.

In block 203, the determined altitude position state of the terminal device is transmitted, as a part of a handover process, to a handover target network node.

In order to avoid carrying out aggressive handover measurements in relation to every handover, the altitude position state of the terminal device (flying or ground based) may be exchanged with regard to a handover decision. In that way normal reporting can be used unless the aggressive reporting is triggered.

In one embodiment, mobility state information is transmitted to the handover target node. The mobility state information may comprise at least one of the following: a type of the at least one indication of the signal reception quality of the plurality of the reports, the number of the plurality of the reports, time period during which the receiving and determining were carried out and a level of the certainty of the determining. Additionally, the mobility state information may comprise at least one of the following: a movement vector and at least one last received indication of the signal reception quality. Handover signaling are explained in more detail below.

In one embodiment, when the network node detects that the terminal device altitude position state has changed, it transmits information on the altitude position state to the terminal device. The terminal device may then adapt its measurement mode accordingly as preconfigured or the network node may transmit a new measurement configuration to the terminal device. It is also an option that the network node transmits a trigger, a “blind” trigger, simply indicating a change in measurement mode.

As to edge cloud, one possible manner to carry out embodiments may be the following: using a distributed computing system, comprising a server and a radio node, the server being configured to: receive from the radio node a plurality of reports comprising at least one indication of signal reception quality at a terminal device the radio node provides a serving radio cell, determine an altitude position state of the terminal device based on comparing the at least one indication of the signal reception quality of the plurality of the reports to a comparison model or based on comparing cells in the plurality of the reports to information of cells in a certain area, and request more reports from the radio node for improved certainty of the determining, if needed, and transmit the determined altitude position state to the radio node. The radio node being configured to: transmit the plurality of reports to the server and in response to being requested, transmit the more reports after requested and received from the terminal device to the server, receive the altitude position state of the terminal device, and transmit, as a part of a handover process, the altitude position state of the terminal device to a handover target network node.

The method ends in block 204 and is repeatable. Below, some examples are given.

FIG. 3 illustrates an example of different measurement results at different altitudes. As can be seen from FIG. 3, a decision line 301 may be drawn to determine which ones of the terminal devices are airborne (above the decision line 301) and which ones are terrestrial (below the decision line). The parameter value for alpha is a slope of the decision line and the parameter value beta is a constant of the decision line. In the illustrated decision line 301, the parameter value for alpha is 0.77 and the parameter value for beta is 57, 2 dB. It should be appreciated that any other values may be used for a decision line.

The decision line may be used, together with received measurement result to be used to estimate the altitude of an airborne terminal device: The base station can estimate the altitude potentially by looking at the distance to the decision line: the further above the decision line the terminal device is the more likely the terminal device is very high in the air.

FIG. 4 illustrates an exemplified functionality of a base station, or more precisely, the functionality of the state detecting unit, relating to one terminal device served by the base station. A plurality of similar processes may run in parallel in the base station.

FIG. 4 starts in block 401 when it is detected that the altitude position state of the terminal device is doubtful. In the below, with FIGS. 5, 6 and 7 couple of examples when altitude position state of doubtful is detected, is disclosed. Further examples include that a terminal device in an idle mode becomes active, a first sample, or another certain amount, less than #, of samples, are on the other side of the decision line. The amount of samples may be different for terrestrial altitude position state than for airborne altitude position state. Further, it should be appreciated that the term “doubtful” state means actually that there is a doubt that the current state may have changed or is to be changed, and therefore the base station may consider the state as doubtful, to differentiate from states that are more definitely known. In other words, when the altitude position state is known with low, i.e. insufficient, reliability, or is a default state, the state is doubtful.

When it is detected that the altitude position state is doubtful, updating measurement triggers in the terminal device to report measurements more frequently, i.e. more aggressively, is caused in block 402. The updating may be performed by dedicated signaling.

The measurement reports are received in block 403 and at least #latest, or at least certain received results, are maintained in block 403 in the memory. The received results that at least are maintained in the memory in this example include reference signal received power (RSRP) of the serving cell, denoted as RSRP_s herein, and reference signal received power of strongest neighbor cells, typically up to 8 strongest neighbor cells.

When there is enough received results, i.e. the number of the result is not less than the number #for a decision window (block 404: no), in block 405 a threshold for RSSI (RSSI_th), using RSRPs, is calculated from each of #latest measurement reports. For example, following equation (1) may be used:

RSSI_th=alpha(RSRP_s−RSRP(1NB))−beta (1)

wherein

RSSI_th=threshold for RSSI, in dB

alpha=value for parameter alpha

RSRP_s=RSRP of the serving cell, in dB

RSRP(1NB)=RSRP of the strongest neighbor, in dB

beta=value for parameter beta, in dB

It should be understood that hysteresis may be used in the decision as well. In other words, the threshold value used in the decision may be the result of equation (1) to which a hysteresis value is added, or from which a hysteresis value is deducted. The hysteresis value can be configured, for example, to be a value between 0 and 30 dB.

The equation (1) is an equation for the decision line illustrated in FIG. 3, when a value for the parameter alpha is 0.77 and a value for the parameter beta is 57, 2 dB. It should be appreciated that any other values may be used for a decision line.

Further, from the sum of the RSRPs a total received wideband signal power (RSSI), also called wideband interference level, is calculated in block 405 for each measurement results.

Then each of the #latest RSSI is compared in block 406 with corresponding RSSI_th. If the value for #is 10, this means that 10 latest RSSIs of the serving cell are compared with corresponding RSSI_ths, calculated using equation (1).

From the comparison results it is checked in block 407, whether each compared RSSI is below corresponding RSSI_th. If not (block 407: no), it is checked in block 408, whether each compared RSSI is above corresponding RSSI_th. If yes (block 408: yes), the altitude position state is detected in block 409 to be terrestrial Since the altitude position state is detected, sending corresponding mobility configuration to the terminal device is caused in block 410. The mobility configuration is used to differentiate mobility settings for airborne altitude position state from mobility settings for terrestrial altitude position state. Further, updating measurement triggers in the terminal device to report measurements normally, i.e. less frequently, is caused in block 410.

If each compared RSSI is below corresponding RSSI_th (block 407: yes), the altitude position state is detected in block 411 to be airborne. Then the process continues to block 410 to causing sending of corresponding mobility configuration and updating measurement reports to arrive less frequently.

If each, or a significant number, possibly preconfigured, compared RSSI is or are not below corresponding RSSI_th (block 407: no) and if each, or a significant number, possibly preconfigured, compared RSSI is or are not above corresponding RSSI_th. (block 408: no), the state remains doubtful, since one cannot conclude with a required probability whether the state is airborne or terrestrial. Therefore, once a new measurement report is received (block 412), or has already been received, the process returns to step 405 to calculate the thresholds. Naturally the previous calculation results may be used, and the calculations are performed only to the newest measurement report(s).

In other words, the aggressive reporting is used as long as the state remains doubtful. For example, using 10 as #, it is possible to reach 99% success rate in detecting the states.

FIG. 5 illustrates another exemplified functionality of a base station, or more precisely, the functionality of the state detecting unit, relating to one terminal device served by the base station. A plurality of similar processes may run in parallel in the base station. In the example of FIG. 5 it is assumed that the altitude position state of the terminal is either airborne or terrestrial, and the state is redetected at certain intervals. The interval triggering the re-detection procedure may define a time (or period) between two consecutive re-detection procedures, or a specific, configurable number of received measurement reports after the state was detected or re-detected to be airborne or terrestrial, or a combination of time and number. For example, it is re-detected if 4 measurement reports have been received or the time within which 3 measurement reports in the normal reporting will be received.

Referring to FIG. 5, once the re-detection of state is triggered (blocked 501: yes), a threshold for RSSI (RSSI_th) and RSSI, using RSRPs, are calculated in block 502 at least from each of those of #latest measurement reports wherefrom those values have not been calculated before, and each of the #latest RSSI is compared in block 502 with corresponding RSSI_th, including those that have been calculated before. Block 502 corresponds to blocks 405 and 406 in FIG. 4. Further, the same principles, described with blocks 407 and 408 above, are used to detect the current state. If the current state is doubtful (block 503: yes), the process proceeds in block 504 to block 401 in FIG. 4 to detect that the altitude position state of the terminal device is doubtful, and continues therefrom.

If the state is not doubtful (block 503: no), it is checked whether the detected state has remained the same.

If the detected state is not the same as the previous one (block 505: no), sending mobility configurations for the detected state is caused in block 506 and then the process starts to monitor when to trigger the re-detection, i.e. proceeds to block 501.

If the detected state is the same as the previous one (block 505: yes), the process starts to monitor when to trigger the re-detection, i.e. proceeds to block 501.

FIGS. 6 and 7 illustrate other exemplified functionalities of a base station, or more precisely, the functionality of the enhanced handover unit, relating to one terminal device to be served by the base station, when the base station is a target node in a handover. A plurality of similar processes may run in parallel in the base station.

Referring to FIG. 6, it is detected in block 601 that a handover to the base station (target cell) is triggered, and in information forwarded during the handover from the source cell (source base station) to the target cell, a altitude position state of the terminal device is received in block 602.

If the received altitude position state is doubtful (block 603: yes), the process proceeds in block 604 to block 401 in FIG. 4 to detect that the altitude position state of the terminal device is doubtful, and continues therefrom. Alternatively it may proceed to block 403 in FIG. 4, thereby omitting causing updating to more frequent reporting, since the terminal device is already reporting more frequently; the source base station has already performed block 402 in FIG. 4.

If the altitude position state is either terrestrial or airborne, i.e. not doubtful (block 603: no), it is waited in block 605 until #measurement reports have been received. Once there is enough measurement reports to detect the altitude position state, the altitude position state is re-detected by the process proceeding in block 606 to block 502 in FIG. 5, and continuing therefrom.

In blocks 604 and 606 the enhanced handover unit ends the processing and the state detecting unit starts processing.

Referring to FIG. 7, it is detected in block 701 that a handover to the base station (target cell) is triggered, and in information forwarded during the handover from the source cell (source base station) to the target cell, a altitude position state of the terminal device, and m measurement reports are received in block 702 from the source, the m being smaller than or equal to #. In other words, as many reports that are received/maintained for the state (re-)detection purpose in the source base station, are forwarded to the target. Naturally #latest measurement reports (when there are so many) are maintained in a memory (block 703).

If the state is doubtful (block 704: yes), it is waited in block 705 at least one measurement report is received, or if less than #reports were received in block 702, until #-m measurement reports are received. In other words, it is waited that there is enough measurement reports for the detection, or if the state has been detected as doubtful, there is at least one new measurement report, replacing the oldest used, available for the state detection process, which is triggered in block 706 by the process proceeding to block 405 in FIG. 4.

If the state is known (block 704: no), it is waited in block 707 until n new measurement reports are received, and then the state re-detection process is triggered in block 708 by the process proceeding to block 502 in FIG. 5.

In blocks 706 and 708 the enhanced handover unit ends the processing and the state detecting unit starts processing. Further, the block 703 is performed as a background process by the state detecting unit, for example.

FIG. 8 illustrates another exemplified functionality of a base station, or more precisely, the functionality of the enhanced handover unit, relating to one terminal device served by the base station, when the base station is a source node in a handover.

Referring to FIG. 8, when it is detected in block 801 that a handover from the base station (currently serving cell) to another base station (target cell) is triggered, sending mobility information in information forwarded during the handover from the source cell (source base station) to the target cell, is caused in block 602. The mobility information comprises information on the altitude position state. The mobility information may also comprise measurement reports and/or other information used and/or needed to determine the altitude position state, like the probability/probabilities. Further, if another process than those described above to determine the altitude position state is used, the mobility information may comprise in addition to information on the altitude position state, information used and/processed by such process.

FIG. 9 illustrates another exemplified functionality of a base station, or more precisely, the functionality of the state detection unit and the enhanced handover unit.

Referring to FIG. 9, measurement reports are received in block 901 from a terminal device (TD), and the altitude position state of the terminal device is detected in block 902 using RSRPs received, including calculating RSSIs, as described above. Further, in response to a handover of the terminal device being triggered, causing sending in block 903 at least a detected altitude position state of the terminal device to the target node (target base station).

Although in the above examples relating to FIGS. 6 and 7 it has been assumed that a altitude position state of the terminal device transmitted during handover from the source base station (source node) to the target base station (target node) may be one of the three possible states described herein, i.e. doubtful, airborne terrestrial, it should be appreciated that one of the airborne or terrestrial may be sent instead of the doubtful. In other words, for example altitude position state “terrestrial” may mean that the altitude position state actually is either terrestrial or doubtful, or the altitude position state airborne may mean that the altitude position state actually is either airborne or doubtful. In such implementations, the altitude position state may be conveyed using one bit. Then it depends on the implementation, whether the receiving base station considers such “two-meaning state” as an doubtful state, and possible triggers the more frequent measurement reporting, or waits for one or more measurement reports to detect doubtful state. However, even if the “two-meaning state” would trigger the more frequent measurement reporting, it is not triggered in every handover.

FIG. 10 illustrates terminal device functionalities relating to the base station configuring altitude position state of the terminal device. Referring to FIG. 11, the terminal device, when receiving (block 1001: yes) from the base station mobility configuration, i.e. mobility state information, updates in block 1002 its configuration correspondingly, and uses it until a new configuration is received.

FIG. 11 illustrates an example in an embodiment in which terminal devices are configured to report an event that indicate a possible change of the mobility state from the terrestrial state to the airborne state, or vice versa.

Referring to FIG. 11, base stations, depicted by BS1, are configured to convey (message 11-1) values for the parameters, such as a value for a configuration parameter and a value for an environment parameter as broadcast and/or in dedicated signaling to terminal devices, like the terminal device TD1. The configuration parameter may be alpha, and the environment parameter beta, and their values may be the same as those used by the base station. Further, depending on the implementation, also values for parameters n and/or #, may be conveyed to terminal devices in one or more messages 11-1.

When the terminal device TD1 receives (block 11-2), the values for the configuration parameter and environment parameter, the terminal device uses them. More precisely, the terminal device, or the event trigger unit in the terminal device, configures, in response to receiving the values (or new values if received as broadcast), in block 11-2 measurement report event triggers to use the value for the configuration parameter and the value for the environment parameter.

Each time the terminal device, or the event trigger unit in the terminal device, detects in block 11-3 a measurement report event in response to an equation, which uses the configuration parameter, the environment parameter, a hysteresis and at least two different measured indications of the signal reception quality of the terminal device, being fulfilled, it sends a measurements report (message 11-4) from the terminal device to the base station (the serving network node). A more detailed example relating to detecting measurement report events is described in more detail below with FIG. 12.

Although not illustrated in FIG. 11, the terminal devices may or may not still receive from base stations instructions causing more frequent reporting and/or returning to normal reporting rate.

FIG. 12 illustrates terminal device functionalities, or more precisely, the functionality of the event trigger unit in an implementation in which terminal devices are configured to report an event that indicate a possible change of the mobility state from the terrestrial state to the airborne state, or vice versa. In the example of FIG. 12, it is assumed that the terminal device is aware of its altitude position state, as configured by the base station. The configuration for terrestrial or airborne may be used in a similar way as is configuration to slow terminal device or fast moving terminal device performed. In other words, a new dimension “airborne” is added. Further, it is assumed that a default state is terrestrial, if no configuration has been received, for example when the radio resource connection (RRC) status changes from idle to active (or from RRC_inactive to RRC-connected), or the terminal device is turned on. Naturally airborne may be used as a default altitude position state, or the terminal device may be configured to remember the last altitude position state and use it as the default state.

The terminal device measures in block 1201 at least reference signal received powers of the serving cell, RSSI (received wideband signal power, i.e. wideband interference level) of the serving cell and reference signal received powers of strongest neighbor cells, the serving cell. Naturally, it may be possible that instead of measuring RSSI, the terminal device calculates RRSI using RSRPs of strongest neighbor cells. After each measurement it is checked in block 1202 whether or not a normal report event is detected. If not, it is checked in block 1203, whether the current altitude position state is terrestrial.

If the current altitude position state is terrestrial (block 1203: yes), a measurement report event is detected in block 1204, if the following equation (2) is true:

RSRP_s<RSRP_n+RSSI/alpha−beta/alpha−H1 (2)

wherein

RSRP_s=RSRP of the serving cell, in dB

RSRP_n=RSRP of the strongest neighbor, in dB

RSSI=measured RSSI or sum of RSRPs, in dB

alpha=value for parameter alpha

beta=value for parameter beta, in dB

H1=hysteresis, which can be configured, for example, to be a value between 0 and 30 dB

Sending a measurement report is caused in block 1205 if the measurement event is detected in block 1204, and the process returns to block 1201 to perform the measurements.

If the current altitude position state is airborne, i.e. not terrestrial (block 1203: no), a measurement report event is detected in block 1206, if the following equation (3) is true:

RSRP_s>RSRP_n+RSSI/alpha−beta/alpha+H2 (3)

wherein

RSRP_s=RSRP of the serving cell, in dB

RSRP_n=RSRP of the strongest neighbor, in dB

RSSI=measured RSSI or sum of RSRPs, in dB

alpha=value for parameter alpha

beta=value for parameter beta, in dB

H2=hysteresis, which can be configured, for example, to be a value between 0 and 30 dB, and the value may be the same as H1, or different from the value of H1.

Sending a measurement report is caused in block 1205 if the measurement event is detected in block 1206, and the process returns to block 1201 to perform the measurements.

The terminal device may send a measurement report when it detects that the decision line, represented by the equations, is crossed.

If a normal report event is detected (block 1202: yes), sending a normal measurement report is caused in block 1205, and the process returns to block 1201 to perform the measurements.

As is evident from the above, the more frequent reporting is used only when needed, i.e. when there is indications on a change. For example, in a handover, there is no need to trigger the detection procedure just to find out the altitude position state, since the information is received with other information forwarded during the handover.

The blocks, related functions, and information exchanges described above by means of FIGS. 2 to 12 are in no absolute chronological order, and some of them may be performed simultaneously or in an order differing from the given one. Naturally similar processes for several terminal devices may run in parallel. Other functions can also be executed between them or within them, and other information may be sent. Some of the blocks or part of the blocks or one or more pieces of information can also be left out or replaced by a corresponding block or part of the block or one or more pieces of information.

The techniques and methods described herein may be implemented by various means so that an apparatus/device/network node/base station/UP-GW configured to support a path and/or source validation mechanism based on at least partly on what is disclosed above with any of FIGS. 1 to 12, including implementing one or more functions/operations of a corresponding network node (eNB, base station) or terminal device described above with an embodiment/example, for example by means of any of FIGS. 2 to 12, comprises not only prior art means, but also means for implementing the one or more functions/operations of a corresponding functionality described with an embodiment, for example by means of any of FIGS. 2 to 12, and it may comprise separate means for each separate function/operation, or means may be configured to perform two or more functions/operations. For example, one or more of the means and/or the state detection unit, or its sub-units, and/or the enhanced handover unit, or its sub-units, and/or the event trigger unit, or its sub-units, described above may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, logic gates, other electronic units designed to perform the functions described herein by means of FIGS. 1 to 12, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components described herein may be rearranged and/or complemented by additional components in order to facilitate the achievements of the various aspects, etc., described with regard thereto, and they are not limited to the precise configurations set forth in the given figures, as will be appreciated by one skilled in the art.

FIG. 13 provides an apparatus (device) according to some embodiments of the invention. FIG. 13 illustrates an apparatus configured to carry out the functions described above in connection with the base station (eNB). Each apparatus may comprise one or more communication control circuitry, such as at least one processor 1302, and at least one memory 1304, including one or more algorithms 1303, such as a computer program code (software) wherein the at least one memory and the computer program code (software) are configured, with the at least one processor, to cause the apparatus to carry out any one of the exemplified functionalities of the base station.

Referring to FIG. 13, at least one of the communication control circuitries in the apparatus 1300 is configured to provide the state detection unit, or its sub-units, and/or the enhanced handover unit, or its sub-units, and/or their combinations, and to carry out functionalities described above by means of any of FIGS. 3 to 9 by one or more circuitries.

FIG. 14 provides an apparatus (device) according to some embodiments of the invention. FIG. 14 illustrates an apparatus configured to carry out the functions described above in connection with the terminal device. Each apparatus may comprise one or more communication control circuitry, such as at least one processor 1402, and at least one memory 1404, including one or more algorithms 1403, such as a computer program code (software) wherein the at least one memory and the computer program code (software) are configured, with the at least one processor, to cause the apparatus to carry out any one of the exemplified functionalities of the terminal device, such as those disclosed by means of FIGS. 10 to 12.

Referring to FIG. 14, at least one of the communication control circuitries in the apparatus 1400 is configured to provide the event trigger unit, or its sub-units unit, and to carry out functionalities described above by means of FIGS. 10, 11 and 12 by one or more circuitries.

Referring to FIGS. 13 and 14, the memory 1304, 1404 may be implemented using any suitable data storage technology, such as semiconductor based memory devices, flash memory, magnetic memory devices and systems, optical memory devices and systems, fixed memory and removable memory.

Referring to FIGS. 13 and 14, the apparatus may further comprise different interfaces 1301, 1401 such as one or more communication interfaces (TX/RX) comprising hardware and/or software for realizing communication connectivity according to one or more communication protocols. The communication interface may provide the apparatus with communication capabilities to communicate in the cellular communication system and enable communication between the terminal devices and different network nodes and in apparatus 1300 depicting the base station also a communication interface to enable communication between the different network nodes, for example. The communication interface may comprise standard well-known components such as an amplifier, filter, frequency-converter, (de)modulator, and encoder/decoder circuitries and one or more antennas. The communication interfaces may comprise radio interface components providing the network node and the terminal device with radio communication capability in the cell.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network de-vice, or another network device.

In embodiments, the at least one processor, the memory, and the computer program code form processing means or comprises one or more computer program code portions for carrying out one or more operations according to any one of the embodiments of FIGS. 2 to 12 or operations thereof.

Embodiments as described may also be carried out in the form of a computer process defined by a computer program or portions thereof. Embodiments of the methods described in connection with FIGS. 2 to 12 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1.-28. (canceled)

29. A method comprising:
receiving, by a serving network node, from a terminal device, a plurality of reports comprising at least one indication of signal reception quality;
determining, by the serving network node, an altitude position state of the terminal device based on comparing the at least one indication of the signal reception quality of the plurality of reports to a comparison model or based on comparing cells in the plurality of reports to information of cells in a certain area, and requesting more reports from the terminal device for improved certainty of the determining, if needed, and
transmitting, as a part of a handover process, the determined altitude position state of the terminal device to a handover target network node.

30. The method according to claim 29, wherein the altitude position state comprises terrestrial or airborne.

31. The method according to claim 29, wherein the at least one indication of the signal reception quality of the plurality of the reports comprises at least one of the following: at least one parameter representing received signal level in a cell provided by the serving network node and at least one parameter representing received signal level in at least one neighbor cell and wherein the comparison model comprises a decision equation using the at least one parameter representing wideband interference, a configuration parameter, an environment parameter and a decision line, and one of the following: the at least one parameter representing received signal level in the cell provided by the serving network node, the at least one parameter representing received signal level in the at least one neighbor cell and at least one parameter indicating wideband interference level.

32. The method according to claim 29, wherein the determining based on the comparing the cells in the plurality of the reports comprises: in the case the information on the cells in the certain area comprises cells measurable by a terminal device having a terrestrial altitude position state and the cells in the plurality of the reports match to the information, the altitude position state of the terminal device is determined as terrestrial and in the case the information on the cells in the certain area comprises cells measurable by a terminal device having an airborne altitude position state and the cells in the plurality of the reports match to the information, the altitude position state of the terminal device is determined as airborne.

33. The method according to claim 29, further comprising:
detecting that the terminal device altitude position state has changed, and
transmitting information on the altitude position state to the terminal device.

34. The method according to claim 29, further comprising:
transmitting, to the handover target node, mobility state information comprising at least one of the following: a type of the at least one indication of the signal reception quality of the plurality of the reports, the number of the plurality of the reports, time period during which the receiving and determining were carried out and a level of the certainty of the determining.

35. The method according to claim 29, further comprising:
transmitting, to the handover target node, mobility state information comprising at least one of the following: a type of the at least one indication of the signal reception quality of the plurality of the reports, the number of the plurality of the reports, time period during which the receiving and determining were carried out and a level of the certainty of the determining, wherein the mobility state information further comprises at least one of the following: a movement vector and at least one last received indication of the signal reception quality.

36. The method according to claim 29, further comprising:
requesting more reports from the terminal device, by updating, by the serving network node, measurements triggers of the terminal device to more frequent reporting; and
updating, in response to detecting that there is not any more need for the improved certainty, by the serving network node, measurements triggers of the terminal device to less frequent reporting.

37. The method according to claim 29, further comprising:
causing sending from the serving network node to the terminal device a value for a configuration parameter and a value for an environment parameter for measurements report event triggers to trigger sending of measurements reports.

38. A network node comprising:
at least one processor, and
at least one memory comprising a computer program code, wherein the processor, the memory, and the computer program code are configured to cause the network node to:
determine an altitude position state of a terminal device, on which a plurality of reports comprising at least one indication of signal reception quality of the terminal device, or corresponding information, have been received, based on comparing the at least one indication of the signal reception quality of the plurality of reports to a comparison model or based on comparing cells in the plurality of reports to information of cells in a certain area, and requesting more reports from the terminal device for improved certainty of the determining, if needed, and
transmit, as a part of a handover process, the determined altitude position state of the terminal device to a handover target network node.

39. The network node according to claim 38, wherein the processor, the memory, and the computer program code are further configured to cause the network node to determine the altitude position state of the terminal device based on a decision equation in the comparison model, the decision equation using a configuration parameter, an environment parameter and a decision line, and one of the following: the at least one parameter representing received signal level in the cell provided by the serving network node, the at least one parameter representing received signal level in the at least one neighbor cell and at least one parameter indicating wideband interference level.

40. The network node according to claim 38, wherein the processor, the memory, and the computer program code are further configured to cause the network node to determine the altitude position state of the terminal device, based on the comparing the cells in the plurality of the reports, to be as terrestrial in the case the information on the cells in the certain area comprises cells measurable by a terminal device having a terrestrial altitude position state and the cells in the plurality of the reports match to the information, and to be as airborne in the case the information on the cells in the certain area comprises cells measurable by a terminal device having an airborne altitude position state and the cells in the plurality of the reports match to the information.

41. The network node according to claim 38, wherein the processor, the memory, and the computer program code are further configured to cause the network node to transmit to the handover target node, mobility state information comprising at least one of the following: a type of the at least one indication of the signal reception quality of the plurality of the reports, the number of the plurality of the reports, time period during which the receiving and determining were carried out and a level of the certainty of the determining.

42. The network node according to claim 38, wherein the processor, the memory, and the computer program code are further configured to cause the network node to use in determining the altitude position state of the terminal device mobility state information received as a handover target node of the terminal device, the mobility state information comprising at least one of the following: a type of the at least one indication of the signal reception quality of the plurality of the reports, the number of the plurality of the reports, time period during which the receiving and determining were carried out and a level of the certainty of the determining.

43. The network node according to claim 38, wherein the processor, the memory, and the computer program code are further configured to cause the network node:
to detect that the terminal device altitude position state has changed; and
transmit information on the altitude position state to the terminal device.

44. A terminal device comprising:
at least one processor, and
at least one memory comprising a computer program code, wherein the processor, the memory, and the computer program code are configured to cause the terminal device to:
configure measurement report event triggers to be in accordance with a value for a configuration parameter and a value for an environment parameter in response to receiving the values from a serving network node;
detect a measurement report event in response to an equation, which uses the configuration parameter, the environment parameter, a hysteresis and at least two different measured indications of the signal reception quality of the terminal device, being fulfilled; and
cause, in response to detecting a measurements report event, sending a measurements report from the terminal device to the serving network node.

45. The terminal device according to claim 44, wherein the processor, the memory, and the computer program code are further configured to cause the terminal device to update its altitude position state in response to receiving information on the altitude position state of the terminal device from the serving network node.

46. The terminal device according to claim 44, wherein the value for the configuration parameter and the value for the environment parameter are received as a broadcast or in dedicated signaling.
